(19) United States
(12) Patent Application Publication
(10) Pub. No.: US 2021/0395538 A1
(43) Pub. Date: Dec. 23, 2021

(54) SOLAR-REFLECTIVE AND COLOR-CHANGING COMPOSITION

(71) Applicant: Joseph Allen Merkel, Centerville, OH (US)

(72) Inventors: Joseph Allen Merkel, Centerville, OH (US); Teresa Marie Merkel, Centerville, OH (US); Andrew Clemens Forsthoefel, Liberty Township, OH (US); Clare Han, Beavercreek, OH (US); Joshua Han, Beavercreek, OH (US); Matthew Charles Lee, Springboro, OH (US); Samuel Erving Geelhood, Beavercreek, OH (US)

(21) Appl. No.: 17/349,995

(22) Filed: Jun. 17, 2021

Related U.S. Application Data
(60) Provisional application No. 63/040,670, filed on Jun. 18, 2020.

(51) Int. Cl. C09D 5/26; C09D 5/33; C09D 7/61; C09D 7/41

(52) U.S. Cl. CPC C09D 5/26; C09D 7/41; C09D 7/61; C09D 5/004

(57) ABSTRACT

A composition comprises a solar-reflective pigment that reflects sunlight (including but not limited to infrared light, visible light, and/or ultraviolet light), thereby retarding the heat accumulation from direct exposure to sunlight. The composition further comprises a thermochromic pigment that changes color at a predefined temperature, thereby providing a visible indication of changing temperature. When the predefined temperature is set to a threshold temperature that is dangerously hot to the touch, the visible indication serves as a warning, thereby reducing the possibility of burns or other injuries.

### CROSS REFERENCE TO RELATED APPLICATIONS

This application claims the benefit of U.S. provisional patent application Ser. No. 63/040,670, filed 2020 Jun. 18, having the title “Solar-Reflective Composition,” which is incorporated herein by reference in its entirety.

### BACKGROUND

### Field of the Disclosure

The present disclosure relates generally to compositions of matter and, more particularly, to solar-reflective and color-changing compositions.

### Description of Related Art

The FIRST® Lego® League (FLL) students on the QuickBots Team (Team Number 32411) learned from published literature that, even on an overcast day, playground equipment (e.g., a slide, a swing seat, etc.) sometimes becomes dangerously hot. Even when ambient temperatures are tolerable, a surface on a playground apparatus or equipment can become hot enough to cause burns when the surface is exposed to sufficient amounts of sunlight.

### SUMMARY

The present disclosure provides a composition of matter that reflects sunlight and changes color. Briefly described, one embodiment of the composition comprises a solar-reflective pigment and a thermochromic pigment. The solar-reflective pigment reflects sunlight (including but not limited to infrared light, visible light, and/or ultraviolet light). The thermochromic pigment changes color at a predefined temperature, thereby providing a visible indication of changing temperature.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a drawing that shows one embodiment of an apparatus or equipment at a safe temperature.

FIG. 2 is a drawing that shows the apparatus or equipment of FIG. 1 when it reaches an unsafe temperature.

FIG. 3 is a drawing that shows another embodiment of an apparatus or equipment at a safe temperature.

FIG. 4 is a drawing that shows the apparatus or equipment of FIG. 3 when it reaches an unsafe temperature.

FIG. 5 is a drawing that shows yet another embodiment of an apparatus or equipment at a safe temperature.

FIG. 6 is a drawing that shows the apparatus or equipment of FIG. 5 when it reaches an unsafe temperature.

FIG. 7 is a drawing of a warning sign at a safe temperature.

FIG. 8 is a drawing that shows the sign of FIG. 7 when it reaches an unsafe temperature.

### DETAILED DESCRIPTION OF THE EMBODIMENTS

The inventors (who are FIRST® Lego® League (FLL) students on the QuickBots Team (Team Number 32411, hereafter “QuickBots”)) learned from published literature that, even on an overcast day and even when ambient temperatures are tolerable, playground equipment (e.g., a surface of a slide, a seat on a swing, etc.) can become dangerously hot. With sufficient exposure to the sun, the surface on playground equipment can still cause burns when it contacts the skin. For young children, this hazard is especially dangerous because, unlike adults, the skin on young children is more susceptible to burns. Additional injuries may occur when children jump or fall off of playground equipment to avoid hot surfaces, with the fall being another potential source of injury.

Hot surfaces are not limited to playground equipment. For example, benches or other seating areas can also become dangerously hot. At best, these hot surfaces cause discomfort. At worst, they cause serious injury, such as severe burns.

To address the dangers associated with surfaces that become hot under the sun, the present disclosure provides a composition of matter that reflects sunlight (e.g., infrared (IR) light, visible light, and/or ultraviolet (UV) light) and changes color. In one embodiment, the composition comprises a solar-reflective pigment (e.g., reflecting at least a portion of the IR, visible, and/or UV spectrum) and a thermochromic pigment. The solar-reflective pigment reflects sunlight (including but not limited to IR light, visible light, and/or UV light), thereby providing a cooler surface than without the solar-reflective pigment. The thermochromic pigment changes color at a predefined temperature, thereby resulting in a visible indication of changing temperature. The change in color provides a visual warning, thereby reducing the possibility of burns.

Having provided a broad technical solution to a technical problem, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

### Unexpected Results and Proceeding Contrary to Accepted Wisdom in the Art

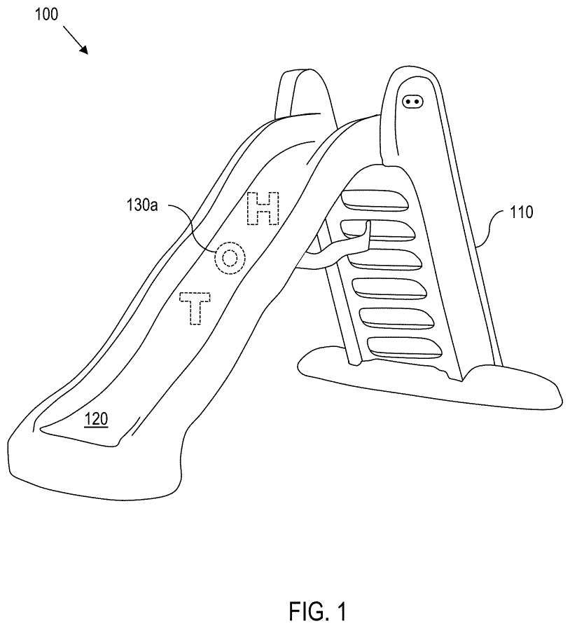

Before addressing the specific embodiments in FIGS. 1 through 8, it should be noted that the disclosed embodiments produced some unexpected results that were contrary to accepted wisdom in the art.

For example, zinc oxide, titanium dioxide, and infrared (IR) reflective pigments have an ability to block parts of the sun's radiation (specifically, a portion of the spectrum in the ultraviolet-A (UVA), a portion in the ultraviolet-B (UVB) range, and a portion in the IR range, respectively). Consequently, conventional wisdom suggests that adding more zinc oxide or more titanium dioxide or more IR-reflective pigments should provide better resistance to heating.

However, several experiments by the QuickBots showed that too much zinc oxide, titanium dioxide, or IR-reflective pigments counteracted the heat-mitigating effects of the compound disclosed below. Consequently, contrary to accepted wisdom, simply adding more zinc oxide, titanium dioxide, or IR-reflective pigments is counterproductive. Thus, there appears to be a particular concentration (in weight percent (wt %)) at which these compounds provide optimal protection.

Here, the QuickBots expected that increasing the relative concentration (or proportion) of IR-reflective pigment would provide better heat reflectivity and, thus, a lower surface temperature (precisely as accepted wisdom in the art would expect). However, test results showed that having a higher percentage of IR-reflective pigment resulted in a higher surface temperature (not a lower surface temperature). For example, under exactly the same test conditions (e.g., same daylight conditions outside (in the sun), same exposure duration, etc.), an IR-reflective blue pigment at 2.91 wt % resulted in a measured surface temperature of 123.5 degrees Fahrenheit (° F.), while a higher proportion of 9.1 wt % IR-reflective blue pigment resulted in a measured surface temperature of 125.2° F. In other words, counterintuitively and contrary to accepted wisdom, a higher concentration of IR-reflective pigment produced worse solar reflection (in direct sunlight) or, correspondingly, an undesirably higher temperature. Even with over triple (3×) the amount of IR-reflective pigment, the results showed unexpectedly poorer performance. To confirm that this was not simply a measurement artifact, the test was repeated with similar outcomes.

In another experiment, under exactly the same test conditions (using a heat lamp, a thermocouple for measurement, and a control panel for a baseline), a formulation with a higher IR-reflective yellow pigment (at 7.7 wt %) performed worse, exhibiting an increase of 4.3° F. from the baseline, than a formulation with less IR-reflective yellow pigment (at 2.4 wt %), which performed better by exhibiting a decrease of 7.7° F. from the baseline. Again, the coating with nearly triple (3×) the amount of IR-reflective pigment (in relevant part, 7.7 wt % IR-reflective pigment; 7.7 wt % titanium dioxide; 6.1 wt % zinc oxide; and 1.9 wt % thermochromic pigment) resulted in an unexpectedly poorer performance (namely, a difference of 12° F.) when compared to the coating with a third (⅓) of the amount of IR-reflective pigment (in relevant part, 2.4 wt % IR-reflective pigment; 8.1 wt % titanium dioxide; 6.5 wt % zinc oxide; and 2.4 wt % thermochromic pigment).

Other experimental results confirmed that a predicted solar reflectivity did not correlate with the amount of reflective pigments but, instead, fluctuated somewhat unpredictably with differing proportions of ingredients. In other words, one could not readily predict the temperature behavior of a particular surface from the proportions of components (e.g., zinc oxide, titanium dioxide, IR-reflective pigments, thermochromic pigments, and base material). Rather, there was a somewhat unpredictable sweet spot or Goldilocks zone (metaphorically speaking) that provided an optimal solar reflectivity and optimal heat performance.

This was the first of the unexpected results (namely, the temperature performance of the composition (which should depend on solar reflectivity) does not correlate directly with the amount of any single component).

Second, in another example, one would expect an uncoated surface to exhibit less friction than a coated or painted surface. Indeed, one of the concerns of the QuickBots was that coating a surface of a slide would make the surface less slippery and, thus, diminish the operability of the slide (after all, the entire purpose of a slide is for sliding). However, upon gathering experimental data (e.g., comparing the degree of friction between a coated surface and an uncoated surface), the QuickBots discovered surprisingly that the coated equipment became significantly more slippery than the uncoated equipment.

Specifically, the QuickBots measured the force that was required to slide a fixed weight along two (2) different surfaces (namely, an unpainted surface and a painted (or coated) surface). The surface friction was inferred from the measured force. Fifteen (15) repeated measurements were taken for two (2) different fabric types (namely, denim jeans and athletic shorts) for a total of sixty (60) measurements (2 surfaces*2 fabric types*15 repetitions=60 total measurements). For denim (jeans), the average measured force was 1.67 Newtons (N) (with a standard deviation (σ)=0.066) for denim jeans on an unpainted surface, but 1.25N (σ=0.065) for a coated surface. For athletic shorts, the average measured force was 1.34N (σ=0.0073) for the unpainted surface, but 0.81N (σ=0.14) for the coated surface. These results showed that the coating did not adversely affect the performance of the slide. Indeed, the coating appeared to decrease the coefficient of friction, thereby improving the performance by a statistically significant amount.

This was the second of the unexpected results (namely, that applying a coating to a surface resulted in a decrease in the coefficient of friction).

Third, one would expect that materials will fail more often under higher impact forces than lower impact forces. Here, several of the coatings were applied to panels, which were subjected to impact testing (performed on behalf of the QuickBots by the University of Dayton Research Institute (UDRI)). For one of the samples (2.4 wt % IR-reflective pigment; 8.1 wt % titanium dioxide; 6.5 wt % zinc oxide; and 2.4 wt % thermochromic pigment), there were more panels that passed the impact testing at the highest impact force setting and fewer panels that passed at a lower impact force setting. In addition to estimating the impact resistance at somewhere between fifty-seven (57) and sixty (60) inch-pounds (in-lb), the individual testing these panels remarked that resistance at higher impact forces (as compared to lower impact forces) was a strange and unexpected result.

This was the third of the unexpected results (namely, some formulations provided a better impact resistance to higher impact forces than to lower impact forces).

In addition to these unexpected results, the coating provides an additional benefit of protecting the coated equipment from degradation due to UV exposure. In other words, with proper application of the coating, a longer lifespan of the apparatus or equipment is possible by weatherizing, rust-proofing, and reducing and delaying the occurrence of heat warping.

With these unexpected results and advantages in mind, attention is turned to several embodiments of the composition, the coating, and the equipment.

### Embodiment of Solar-Reflective and Color-Changing Composition

In one embodiment, a solar-reflective and color-changing composition is disclosed. Broadly, one embodiment of the composition comprises a solar-reflective pigment and a thermochromic pigment. The solar-reflective pigment reflects sunlight (including but not limited to certain portions of the IR spectrum, visible light spectrum, and/or UV spectrum), thereby providing a cooler surface than without the solar-reflective pigment. The thermochromic pigment changes color at a predefined temperature, thereby resulting in a visible indication of changing temperature. The change in color provides a visual warning, thereby reducing the possibility of burns or other injuries caused by hot surfaces. Thus, when the composition is applied to a surface, the solar-reflective pigment permits longer exposure of the surface to sunlight before the surface becomes dangerously hot. When the effects of the solar-reflective pigment are no longer sufficient to maintain a safe temperature and the surface temperature rises above a threshold temperature, the thermochromic pigment changes color to warn of a dangerously hot surface. For some embodiments, the solar-reflective pigment comprises zinc oxide, titanium dioxide, and an IR-reflective pigment.

By way of example, the thermochromic pigment in one embodiment changes from a first color (e.g., blue, to signify safety) to a second color (e.g., red, to signify danger). Because those having skill in the art understand the workings of thermochromic pigments, only a truncated discussion of thermochromic pigments is provided herein. Preferably, the thermochromic pigment changes color at a threshold temperature of approximately 110 degrees Fahrenheit (˜110° F.) or approximately forty-three degrees Celsius (˜43° C.). Thus, if the temperature rises from below the threshold temperature to above the threshold temperature, then the compound changes from one color (designated as a safe color) to a different color (designated as a danger color). Conversely, when the temperature falls below the threshold temperature, the compound changes from the danger color back to the safe color. In some embodiments, the compound reverts back to the safe color at a temperature that is lower than the threshold temperature, thereby exhibiting hysteresis. The color-change can exhibit hysteresis in both the forward direction (safe to unsafe) as well as the reverse direction (unsafe to safe).

One should understand that this threshold temperature can be adjusted upward or downward, depending on the specific preferences, needs, or uses of the composition. For example, some surfaces (e.g., plastic or rubber) feel cooler to the touch than other surfaces (e.g., metal). Consequently, depending on the surface, sufficient protection from burns is possible with higher or lower threshold temperatures.

Additionally, although ˜110° F. (or ˜43° C.) is provided in an example embodiment, it should be appreciated that the threshold temperature for other embodiments can be higher (e.g., ˜120° F. (or ˜49° C.)) or lower (e.g., ˜90° F. (or ˜32° C.)). It should also be appreciated that other embodiments comprise multiple thermochromic pigments with different threshold temperatures, such as, for example, blue for below ˜90° F. (or ˜32° C.), which designates a safe temperature, and then yellow between ˜90° F. (or ˜32° C.) and ˜110° F. (or ˜43° C.), which warns that one should not maintain contact for extended periods of time, and then red above ˜110° F. (or ˜43° C.), which designates a dangerous temperature.

A narrower embodiment of the composition comprises at least five (5) separate ingredients: (1) zinc oxide; (2) titanium dioxide; (3) a solar-reflective pigment (or an IR-reflective pigment); (4) a thermochromic pigment (or color-changing pigment); and (5) a base, which, in one embodiment, is a clear base or a clear paint. For some embodiments, the zinc oxide and the titanium dioxide reflect sunlight in the UVA and UVB spectra, while the IR-reflective pigment reflects sunlight in the IR and visible spectra. Thus, in combination, the zinc oxide, titanium dioxide, and IR-reflective pigment permit longer exposure to the sun and retard heat accumulation.

Preferably, one embodiment of the composition comprises: between approximately five percent by weight (˜5 wt %) and approximately twenty-five percent by weight (˜25 wt %) zinc oxide; between approximately seven percent by weight (˜7 wt %) and approximately fifteen percent by weight (˜15 wt %) titanium dioxide; between approximately two percent by weight (˜2 wt %) and approximately ten percent by weight (˜10 wt %) of a thermochromic pigment; between ˜2 wt % and approximately twelve percent by weight (˜12 wt %) of a solar-reflective (or, alternatively, IR-reflective) pigment; and a balance of the 100 wt % being a clear base, such as, for example, a clear paint.

In one example embodiment, the composition comprises ˜6.45 wt % of zinc oxide; ˜8.06 wt % of titanium dioxide; ˜2.42 wt % of a thermochromic pigment; ˜2.42 wt % of an infrared (IR) reflective pigment; and ˜80.65 wt % of a clear and rust-resistant base paint.

Thermochromic pigments and infrared pigments prevent the composition from being white (which is the color that generally reflects the most amount of light). However, a white color is not necessarily desirable for outdoor equipment because dirt, mold, and other signs of age and/or wear are more visible on a white surface. Thus, for a business or a community, a non-white compound (used in, for example, a coating (as described below)) is aesthetically more pleasing. However, it should be appreciated that there are some instances in which the first color or the second color is white to help reflect more sunlight or for other reasons.

Insofar as thermochromic pigments and IR-reflective pigments are available for purchase from various vendors (e.g., The Shepherd Color Company, 4539 Dues Drive, Cincinnati, Ohio 45246), and because such thermochromic pigments and IR-reflective pigments are known to those having skill in the art, only a truncated discussion of IR-reflective pigments and thermochromic pigments is provided in this disclosure. Instead, this disclosure focuses more on the combination of materials that form the compound and the unexpected results that are obtained from the disclosed combination.

### Embodiment of Solar-Reflective and Color-Changing Coating

In another embodiment, a solar-reflective and color-changing coating is disclosed. The coating comprises the compound (as discussed above). Because the compound is provided as a coating, it can be applied to various surfaces, such as playground equipment (e.g., surfaces of slides, seats on swings, etc.), park benches, or any other surface that could become too hot. The application of the coating to these surfaces reflects sunlight from these surfaces and, therefore, hinders surface heating from exposure to the sun. If the surface nevertheless becomes too hot, then the coating changes color to provide a visual indication that the surface temperature has become dangerous.

One embodiment of the coating comprises of a formulation of at least five (5) separate ingredients. For example, in one embodiment, among others, the coating comprises: (1) zinc oxide; (2) titanium dioxide; (3) a solar-reflective (or, alternatively, IR-reflective) pigment; (4) a thermochromic pigment; and (5) a clear base. For some embodiments, the clear base comprises a clear paint.

Similar to the composition, as described above, one embodiment of the coating comprises: between ˜5 wt % and ˜25 wt % zinc oxide; between ˜7 wt % and ˜15 wt % titanium dioxide; between ˜2 wt % and ˜10 wt % of thermochromic pigment; and between ˜2 wt % and ˜12 wt % of solar-reflective (or, alternatively, IR-reflective) pigment. The balance of the 100 wt % is a clear base, such as, for example, a clear paint. In one preferred embodiment, the specific percentages within the coating include: ˜6.45 wt % of zinc oxide; ˜8.06 wt % of titanium dioxide; ˜2.42 wt % of a thermochromic pigment; ˜2.42 wt % of an infrared (IR) reflective pigment; and ˜80.65 wt % of a clear and rust-resistant base paint.

By reflecting as much solar radiation as possible, the solar reflective coating can prolong the time that outdoor equipment can be exposed to the sun before it becomes too hot to be safe. Zinc oxide and titanium dioxide mainly reflects ultraviolet and visible radiation. Infrared reflective pigments reflect infrared radiation. As a result, the solar reflective coating can reduce the surface temperature of outdoor equipment by up to ˜30° F. (or ˜17° C.), or even more depending on the composition, and increase the total solar reflectance by over seventy-five percent (>75%).

When the zinc oxide, titanium dioxide, and infrared reflective pigments can no longer keep the outdoor equipment cool enough to be safe to touch, the thermochromic pigment is formulated to change color from a first color to a second color at a desired temperature (e.g., ˜110° F. (or ˜43° C.)), or other temperatures that may be too hot for skin contact. The desired temperature may be any temperature that is deemed unsafe to touch or lead to potential injury.

In other embodiments, there is more than one color change. An example of such an embodiment is: blue for below ˜90° F. (˜32° C., which designates a safe temperature), and then yellow between ˜90° F. and ˜110° F. (or between ˜32° C. and ˜43° C., which warns that one should not maintain contact for extended periods of time), and then red above ˜110° F. (˜43° C., which designates a dangerous temperature).

### Embodiment of Solar-Reflective and Color-Changing Words on Playground Equipment

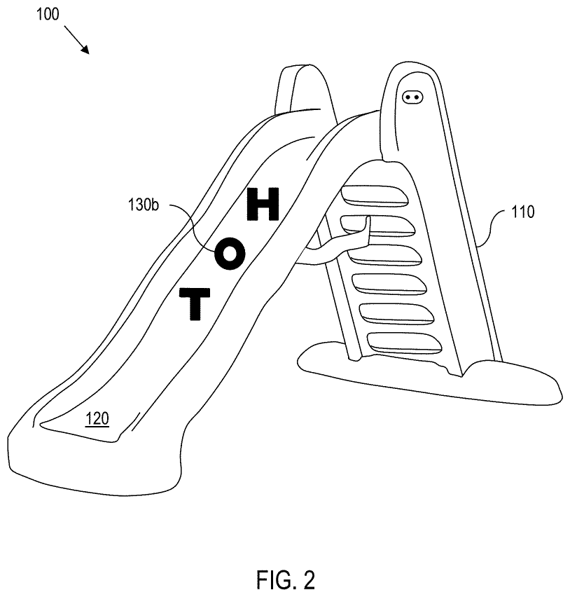

Turning now to FIG. 1, one embodiment of equipment 100 (also designated herein as an apparatus) is shown as a playground slide 110. Specifically, the slide 110 comprises a sliding surface 120 with a word 130a, such as “hot” (or “do not touch” or other similar warning), painted onto the surface 120 of the slide 110 in the same color as the surface 120. Because the color of the word 130a is the same as the color of the surface 120, the appearance of the word 130a is masked and appears virtually invisible to the naked eye when the temperature of the surface 120 is safe. In other words, if the surface 120 of the slide 110 is safe, then no word 130a appears on the surface 120. Conversely, and as shown in FIG. 2, if the surface 120 of the slide 110 reaches an unsafe temperature, then the thermochromic pigment changes color, thereby making the word 130b appear on the surface 120. When the temperature falls below the threshold, the coating on the equipment reverts back to the first color and once again masks the word 130a. In some embodiments, the coating on the equipment reverts back to the first color at a temperature lower than the desired temperature, thereby exhibiting hysteresis (as noted above).

It should be appreciated that any warning words can be painted onto the surface 120. For some embodiments, the word “safe” can be painted onto the surface 120 in a color that is different than the surface 120, with the word changing color to match the color of the surface 120 when the surface becomes dangerously hot. In other words, instead of having the word “hot” appear above the threshold temperature, one can configure the word “safe” to disappear above the threshold temperature. For other embodiments, both of the words “hot” and “safe” can be used together so that the word “safe” disappears at approximately the same time that the word “hot” (or “danger”) appears on the surface.

### Embodiment of Solar-Reflective and Color-Changing Benches

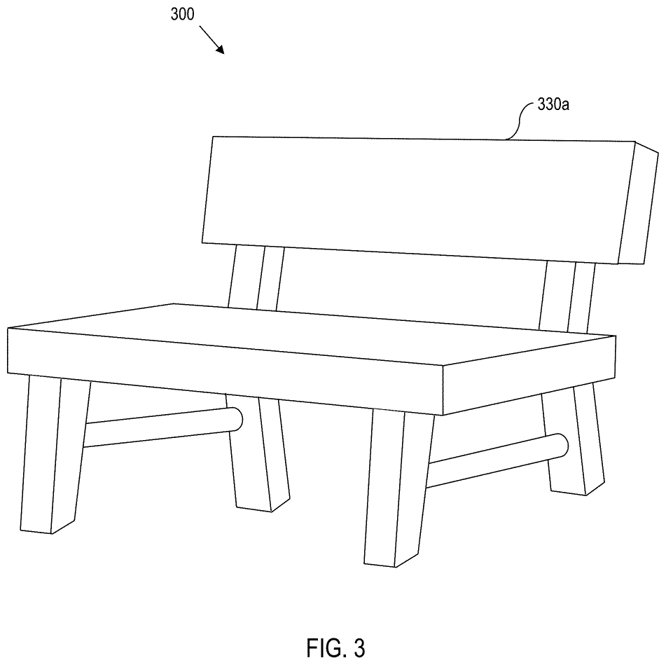

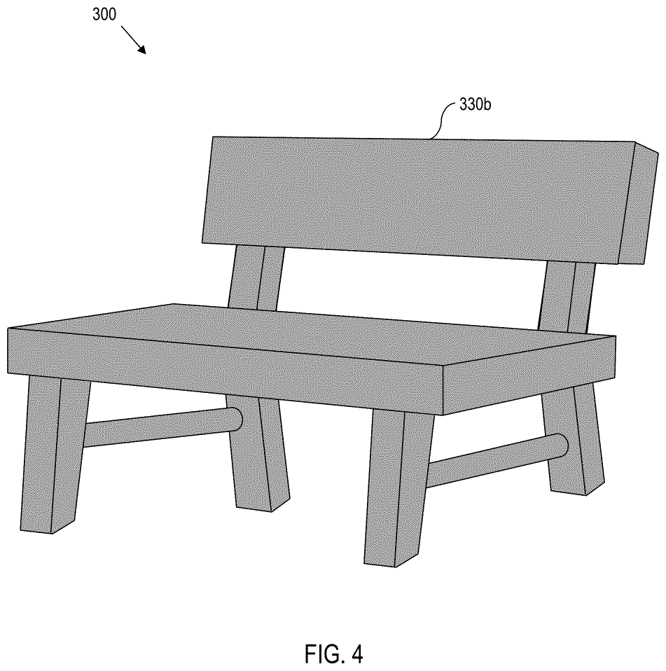

The embodiment of FIGS. 3 and 4 show a color-changing bench 300. As shown in FIGS. 3 and 4, the entire bench 300 is painted with the coating 330a (described above). Thus, the solar-reflective components in the coating 330a, 330b allows the bench 300 to stay cooler for a longer period of time while in the sun. When the temperature of the bench 300 rises above a predefined threshold temperature, then the entire bench 300 changes color because of the thermochromic pigment in the coating 330a, 330b. Although FIGS. 3 and 4 show the bench 300 turning from a white coating 330a color to a black coating 330b color, it should be appreciated that the colors can be any two (2) different colors to designate safe (sufficiently cool) and dangerous (too hot).

Also, when applied to the bench 300, the coating 330a, 330b increases the lifespan by weatherizing, rust-proofing, and reducing and delaying the occurrence of heat warping of the bench 300. Of course, the same can be said of any other type of equipment (meaning, the lifespan is extendable with a durable coating 330a, 330b). Further, as discussed above, the coating 330a, 330b keeps the bench 300 (or other equipment) cooler to the touch and provides a visual indication of whether the bench 300 (or other equipment) is safe.

Yet another advantage is that the solar-reflective and thermochromic coating 330a, 330b can be used to retrofit existing equipment instead of requiring new equipment. In the end, the coating 330a, 330b keeps people, especially children, safe from injuries due to hot equipment.

Upon gathering data (e.g., temperature comparisons, friction testing, weather testing, impact testing, etc.), the QuickBots analyzed the data with conventional statistical methods. The results showed that several formulations of the coating exhibited a significantly higher total solar reflectance than the uncoated equipment (using a P-value of 0.01 to show statistical significance). As noted above, surprisingly, the solar reflective coating had material properties that reduced the coefficient of friction (as compared to an uncoated or unpainted surface).

### Embodiment of Solar-Reflective and Color-Changing Logos

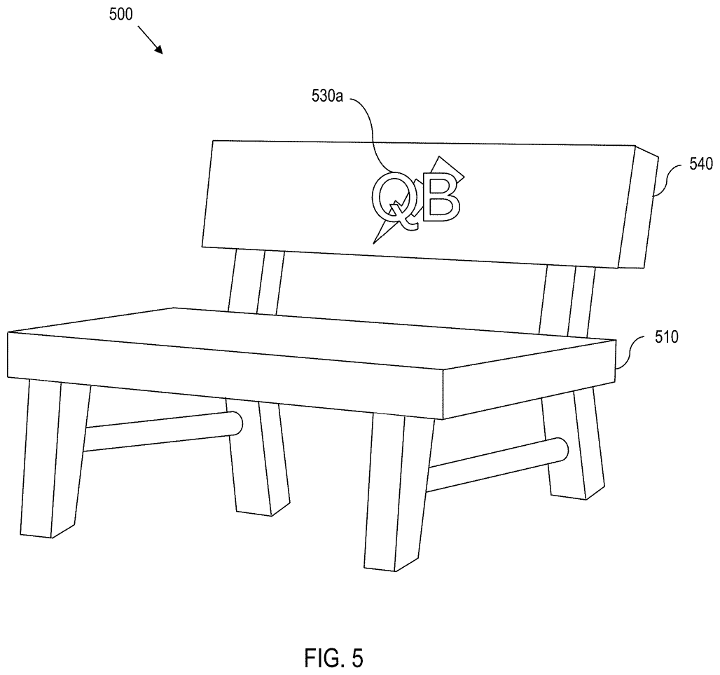

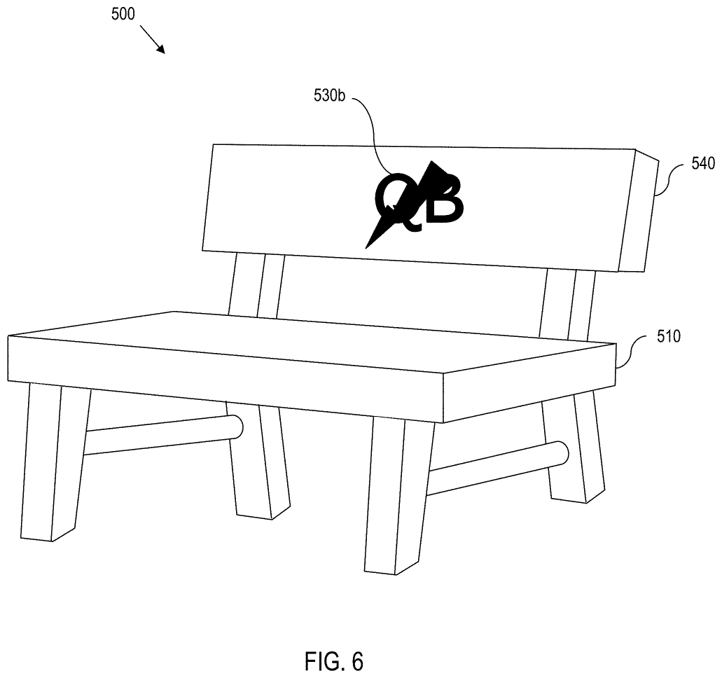

Rather than coating the entire bench 300, for some embodiments, a logo or a symbol is painted onto the bench. This is shown in FIGS. 5 and 6. Specifically, FIG. 5 shows one embodiment of the equipment 500 as a bench 510 with logo 530a of some sort painted onto the surface of the bench 510 with the coating on the frontside of a backrest 540. When the temperature is safe, the logo 530a appears in one color. However, as shown in FIG. 6, when the temperature is unsafe, the logo 530b appears in a different color. The logo 530a, 530b (collectively 530) changes back-and-forth as the temperature of the bench 510 rises and falls with reference to the threshold temperature.

From a marketing perspective, the embodiment having the logo 530 is particularly appealing to universities or businesses with a recognizable symbol. For example, the bench 510 exhibits the QuickBots symbol 530a in one color when it is safe and exhibits the QuickBots symbol 530b in a different color when it is unsafe. As another example, if the bench 510 is on the University of Michigan campus, then the bench 510 itself can have a blue coating with a maize-color “M” logo 530a when the bench 510 is at a safe temperature. If the temperature rises above a dangerous threshold temperature, then the bench 510 color can change from blue to yellow, while the logo 530b changes from yellow to blue (meaning, the bench color and the logo color switch). Similarly, if the bench 510 is on the campus of The Ohio State University (OSU), then the colors can switch between scarlet and grey. As one can imagine, using a logo or symbol serves a two-fold purpose of increasing brand recognition while providing a safer environment.

From a public relations perspective, the two-fold result of increasing brand recognition and improving safety can also improve the good will of the entity within the local community (by showing that the particular entity is concerned about the safety of the children in the community).

### Embodiment of Solar-Reflective and Color-Changing Warning Signs

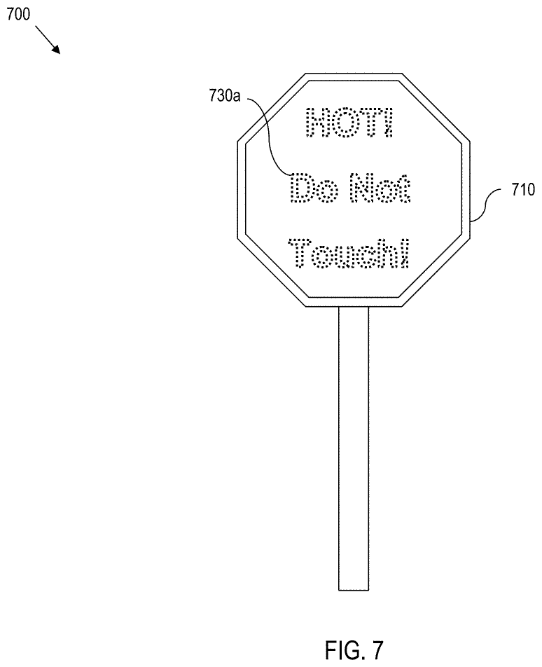

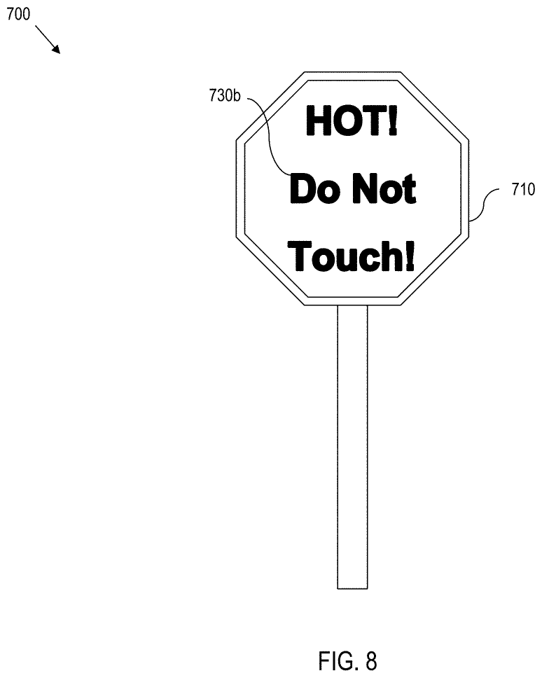

When it is impractical or impossible to directly apply the coating to a piece of equipment, an alternative embodiment 700 (as shown in FIG. 7 and FIG. 8) is a temperature-sensitive, color-changing sign 710. The sign 710 is made from the same material as the equipment so that the temperature of the sign 710 mimics the temperature of the equipment. For such an embodiment, a warning message 730a is painted onto the sign 710 in the same color as the background, thereby (again) masking the presence of the message 730a. When the temperature of the sign 710 becomes too hot (meaning, the temperature rises above a predefined threshold temperature), the message 730b appears on the sign to warn users of the dangerous temperature of the equipment.

### Advantages and Results

As shown in the embodiments of FIGS. 1 through 8, the disclosed solar-reflective and thermochromic compound provides a two-fold function of retarding the heat accumulation in equipment (e.g., slides, swings, benches, etc.) and providing a visual indication of when the equipment reaches a dangerous temperature. By doing so, the disclosed embodiments provide safer environments for everyone, especially children, by reducing the potential for burns or other injuries that can be caused by hot playground equipment.

Additionally, in providing a mechanism by which logos or symbols can be painted onto equipment, the disclosed embodiments have the additional benefit of improving brand recognition, while concurrently making the environment safer.

Although exemplary embodiments have been shown and described, it will be clear to those of ordinary skill in the art that a number of changes, modifications, or alterations to the disclosure as described may be made. For example, although red, yellow, and blue are selected as example colors, it should be appreciated that any two (2) different colors can be used to show a color change, such as, for example, red, orange, yellow, green, blue, cyan, purple, white, black, brown, magenta, tan, olive, maroon, navy, aquamarine, turquoise, silver, lime, teal, indigo, violet, pink, gray, etc., or any combination thereof. Of course, it is preferable to select two (2) colors that are readily distinguishable from each other by visual inspection (e.g., red and blue), rather than selecting two (2) colors that, although distinct, are similar (e.g., aquamarine and turquoise).

These, and other such changes, modifications, and alterations, should therefore be seen as within the scope of the disclosure.

What is claimed is:

1. A coating, comprising:
between approximately five percent by weight (˜5 wt %) and approximately twenty-five percent by weight (˜25 wt %) of zinc oxide;
between approximately seven percent by weight (˜7 wt %) and approximately fifteen percent by weight (˜15 wt %) of titanium dioxide;
between approximately two percent by weight (˜2 wt %) and approximately ten percent by weight (˜10 wt %) of a thermochromic pigment, the thermochromic pigment having a material property of changing from a first color to a second color when above a threshold temperature, the first color being visibly different than the second color, the thermochromic pigment further changing from the second color to the first color when below the threshold temperature, the threshold temperature being one selected from the group consisting of:
approximately forty-nine degrees Celsius (˜49° C.);
˜43° C.;
˜32° C.;
a temperature that is below ˜32° C.;
a temperature that is above ˜49° C.;
a temperature that is between ˜32° C. and ˜43° C.; and
a temperature that is between ˜43° C. and ˜49° C.;
between ˜2 wt % and approximately twelve percent by weight (˜12 wt %) of an infrared (IR) reflective pigment; and
a remaining weight percent comprising a base.

2. The coating of 1, wherein:
the zinc oxide is approximately 6.45 weight percent (˜6.45 wt %) of the coating;
the titanium dioxide is ˜8.06 wt % of the coating;
the thermochromic pigment is ˜2.42 wt % of the coating;
the IR-reflective pigment is ˜2.42 wt % of the coating; and
the base is ˜80.65 wt % of the coating.

3. The coating of 1, wherein:
the first color is one selected from the group consisting of: red; orange; yellow; green; blue; cyan; purple; white; black; brown; magenta; tan; olive; maroon; navy; aquamarine; turquoise; silver; lime; teal; indigo; violet; pink; gray; and any combination thereof; and
the second color is a different one selected from the group consisting of: red; orange; yellow; green; blue; cyan; purple; white; black; brown; magenta; tan; olive; maroon; navy; aquamarine; turquoise; silver; lime; teal; indigo; violet; pink; gray; and any combination thereof.

4. A composition of matter, comprising:
a solar-reflective pigment; and
a thermochromic pigment having a material property of changing from a first color to a second color when above a threshold temperature, the first color being visibly different than the second color, the thermochromic pigment further changing from the second color to the first color when below the threshold temperature.

5. The composition of 4, the threshold temperature being approximately forty-nine degrees Celsius (˜49° C.).

6. The composition of 4, the threshold temperature being approximately forty-three degrees Celsius (˜43° C.).

7. The composition of 4, the threshold temperature being approximately thirty-two degrees Celsius (˜32° C.).

8. The composition of 4, the solar-reflective pigment comprising:
zinc oxide;
titanium dioxide; and
an IR-reflective pigment.

9. The composition of 8, further comprising a base.

10. The composition of 9, wherein:
the zinc oxide is between approximately five percent by weight (˜5 wt %) and approximately twenty-five percent by weight (˜25 wt %) of the composition;
the titanium dioxide is between approximately seven percent by weight (˜7 wt %) and approximately fifteen percent by weight (˜15 wt %) of the composition;
the thermochromic pigment is between approximately two percent by weight (˜2 wt %) and approximately ten percent by weight (˜10 wt %) of the composition;
the IR-reflective pigment is between ˜2 wt % and approximately twelve percent by weight (˜12 wt %) of the composition; and
a remaining portion of the composition comprises the base.

11. The composition of 10, wherein:
the zinc oxide is approximately 6.45 weight percent (˜6.45 wt %) of the composition;
the titanium dioxide is ˜8.06 wt % of the composition;
the thermochromic pigment is ˜2.42 wt % of the composition;
the IR-reflective pigment is ˜2.42 wt % of the composition; and
the base is ˜80.65 wt % of the composition.

12. The composition of 4, the first color being one selected from the group consisting of: red; orange; yellow; green; blue; cyan; purple; white; black; brown; magenta; tan; olive; maroon; navy; aquamarine; turquoise; silver; lime; teal; indigo; violet; pink; gray; and any combination thereof.

13. The composition of 4, the second color being one selected from the group consisting of: red; orange; yellow; green; blue; cyan; purple; white; black; brown; magenta; tan; olive; maroon; navy; aquamarine; turquoise; silver; lime; teal; indigo; violet; pink; gray; and any combination thereof.

14. An apparatus, comprising:
a surface having a coefficient of friction; and
a coating that coats at least a portion of the surface, the coating comprising:
a solar-reflective pigment; and
a thermochromic pigment having a material property of changing from a first color to a second color when above a threshold temperature, the first color being visibly different than the second color, the thermochromic pigment further changing from the second color to the first color when below the threshold temperature.

15. The apparatus of 14, the threshold temperature being one selected from the group consisting of:
approximately forty-nine degrees Celsius (˜49° C.);
˜43° C.;
˜32° C.;
a temperature that is below ˜32° C.;
a temperature that is above ˜49° C.;
a temperature that is between ˜32° C. and ˜43° C.; and
a temperature that is between ˜43° C. and ˜49° C.

16. The apparatus of 14, the solar-reflective pigment comprising:
zinc oxide;
titanium dioxide; and
an IR-reflective pigment.

17. The apparatus of 16, the coating having a material property that decreases the coefficient of friction, the coating further comprising a base.

18. The apparatus of 17, wherein:
the zinc oxide is between approximately five percent by weight (˜5 wt %) and approximately twenty-five percent by weight (˜25 wt %) of the composition;
the titanium dioxide is between approximately seven percent by weight (˜7 wt %) and approximately fifteen percent by weight (˜15 wt %) of the composition;
the thermochromic pigment is between approximately two percent by weight (˜2 wt %) and approximately ten percent by weight (˜10 wt %) of the composition;
the IR-reflective pigment is between ˜2 wt % and approximately twelve percent by weight (˜12 wt %) of the composition; and
a remaining portion of the composition comprises the base.

19. The apparatus of 18, wherein:
the zinc oxide is approximately 6.45 weight percent (˜6.45 wt %) of the composition;
the titanium dioxide is ˜8.06 wt % of the composition;
the thermochromic pigment is ˜2.42 wt % of the composition;
the IR-reflective pigment is ˜2.42 wt % of the composition; and
the base is ˜80.65 wt % of the composition.

20. The apparatus of 14, wherein:
the first color is one selected from the group consisting of: red; orange; yellow; green; blue; cyan; purple; white; black; brown; magenta; tan; olive; maroon; navy; aquamarine; turquoise; silver; lime; teal; indigo; violet; pink; gray; and any combination thereof; and
the second color is a different one selected from the group consisting of: red; orange; yellow; green; blue; cyan; purple; white; black; brown; magenta; tan; olive; maroon; navy; aquamarine; turquoise; silver; lime; teal; indigo; violet; pink; gray; and any combination thereof.
